(19) United States
(12) Patent Application Publication
(10) Pub. No.: US 2013/0072095 A1
(43) Pub. Date: Mar. 21, 2013

(54) INTERNAL GEAR GRINDING MACHINE

(71) Applicant: Christian Hoerner, Altusried (DE)

(72) Inventor: Christian Hoerner, Altusried (DE)

(73) Assignee: LIEBHERR-VERZAHNTECHNIK GMBH, Kempten (DE)

(21) Appl. No.: 13/612,536

(22) Filed: Sep. 12, 2012

(30) Foreign Application Priority Data
Sep. 15, 2011 (DE) 10 2011 113 489.5

(51) Int. Cl. B23F 23/00; B23F 21/02; B23F 15/00

(52) U.S. Cl. 451/259; 451/177

(57) ABSTRACT

The present disclosure relates to an internal gear grinding machine with a grinding arm, on which a grinding spindle is arranged, and with an adjustable coolant nozzle, wherein the coolant nozzle is adjustable via a drive.

### CROSS REFERENCE TO RELATED APPLICATION

This application claims priority to German Patent Application No. 10 2011 113 489.5, entitled “Internal Gear Grinding Machine,” filed Sep. 15, 2011, which is hereby incorporated by reference in its entirety for all purposes.

### TECHNICAL FIELD

The present disclosure relates to an internal gear grinding machine with a grinding arm, on which a grinding spindle is arranged, and with an adjustable coolant nozzle.

To bring the cooling lubricant into the machining zone during gear grinding, coolant nozzles are employed, via which the coolant is brought into the region of engagement of the grinding wheel with the workpiece. As during the grinding operation the grinding wheel diameter is reduced due to abrasion and due to the dressing of the grinding wheel, adjustable coolant nozzles are known, so that the position of the coolant nozzle can be adapted to the grinding wheel diameter.

### BACKGROUND AND SUMMARY

In internal gear grinding machines, in which only little installation space is available in the region of the grinding wheel, manually adjustable coolant nozzles are employed in the prior art, which are arranged laterally beside or extending in radial direction above the grinding wheel.

It is the object of the present disclosure to provide an internal gear grinding machine with an adjustable coolant nozzle, which is easier to handle and/or which better utilizes the installation space present in the internal gear grinding machine.

In accordance with the present disclosure, this object is solved by internal gear grinding machines with a grinding arm, on which a grinding spindle is arranged, and with an adjustable coolant nozzle. In accordance with the present disclosure it now is provided that the coolant nozzle is adjustable via a drive. Due to the use of a drive, the coolant nozzle no longer must be readjusted manually, but can be adapted to the decreasing grinding wheel diameter via the drive, for example during grinding operation. Advantageously, this is an electric drive, via which the adjustment of the coolant nozzle can be performed.

Furthermore, the internal gear grinding machine can include a controller which actuates the drive for adjusting the coolant nozzle and readjusts the coolant nozzle. In accordance with the present disclosure, the readjustment of the coolant nozzle thus can be effected via the NC controller of the grinding machine.

Advantageously, the controller is designed such that the readjustment of the coolant nozzle is effected automatically, and in particular is performed automatically during the grinding operation. In particular, the readjustment can be effected by the controller with reference to a calculated change in size of the grinding wheel.

Alternatively or in addition, the readjustment can be effected by the controller with reference to the profile of the grinding wheel deposited in the machine control unit. In particular, the same data on the shape of the grinding wheel, which are used as basis for the movement of the grinding head during the grinding operation, also can be used for the readjustment of the coolant nozzle in accordance with the present disclosure.

In accordance with the present disclosure it can furthermore be provided that the coolant nozzle is arranged above the grinding wheel on the grinding arm.

In the internal gear grinding machine according to the present disclosure, the grinding spindle is arranged on a grinding arm via which it can be moved into the workpiece in immersion direction, in order to machine the internal toothing of the workpiece from inside. The grinding arm therefore extends in immersion direction and by its length defines the maximum possible width of the gear wheel, which can be ground with the internal gear grinding machine. Due to the arrangement of the coolant nozzle according to the present disclosure, the installation space available anyway at the grinding arm above the grinding spindle is utilized, while the installation space conditions otherwise limited in the region of the grinding spindle can be taken into account in the internal gear grinding machine.

The installation space present at the grinding arm above the grinding wheel also makes the use of a drive for the coolant nozzle particularly easy.

Particularly advantageously, the coolant nozzle of an internal gear grinding machine according to the present disclosure is shiftably guided via a linear guideway.

Advantageously, the linear guideway is arranged in the grinding plane of the grinding wheel, i.e. the adjustment direction of the linear guideway extends in a plane which is vertical to the axis of rotation of the grinding spindle, wherein the linear guideway advantageously is arranged in the plane defined by the grinding wheel and the grinding spindle, respectively. As compared to a lateral arrangement, this has the advantage that the coolant can be applied onto the grinding region more easily and only one coolant nozzle must be used.

Furthermore, it can be provided in accordance with the present disclosure that the linear guideway includes an anti-rotation protection. This prevents that the orientation of the nozzle is changed inadvertently, without the same having to be clamped for this purpose like in the prior art. In a particularly advantageous way, the anti-rotation protection is used when the linear guideway is arranged in the grinding plane, as due to the central arrangement of the coolant nozzle no change of the orientation of the coolant nozzle is required here during the adjustment in longitudinal direction.

According to a second aspect, the present disclosure comprises an internal gear grinding machine with a grinding arm on which a grinding spindle is arranged, with a coolant nozzle adjustable via a linear guideway.

In accordance with the present disclosure it is provided that the adjustment direction of the linear guideway is inclined with respect to the immersion direction and/or with respect to a plane vertical to the immersion direction. Advantageously, the angle of the adjustment direction of the linear guideway to the plane vertical to the immersion direction is between 5° and 40°. This results in a better kinematics during the readjustment of the coolant nozzle. In particular, the coolant nozzle thus is moved not only in immersion direction, but also in engagement direction, and thus will better be adapted to the position of the engagement region of the grinding wheel changing with the size of the grinding wheel.

Alternatively or in addition, the adjustment direction of the linear guideway can extend tangentially to the circumference of the grinding wheel. Although the coolant nozzle should be adapted to a radial change in size of the grinding wheel, such arrangement nevertheless allows a sufficient adaptation to the changing grinding wheel and requires considerably less installation space in radial direction.

Particularly advantageously, the tangentially extending adjustment direction of the linear guideway is inclined with respect to a plane vertical to the immersion direction.

In the above-described configurations according to the second aspect it can furthermore be provided that the adjustment direction of the linear guideway extends upwards towards the nozzle-side end.

Advantageously, the coolant nozzle furthermore is oriented transversely to the adjustment direction of the linear guideway. In particular, the jet centerline of the coolant nozzle can include an angle between 45° and 135°, furthermore advantageously between 60° and 120°, furthermore between 80° and 100°.

Alternatively or in addition, it can be provided in the present disclosure that the spraying direction of the coolant nozzle is arranged with an inclination to the direction of immersion of the grinding head into the workpiece, advantageously in an angular range between 5° and 40°, with the spraying direction advantageously extending forwards and downwards towards the workpiece.

The first aspect of the present disclosure can be used independent of the second aspect of the present disclosure. Particularly, however, both aspects are used in combination. In the following, advantageous developments of the present disclosure will now be described, which each can be employed in grinding machines according to both aspects.

It can be provided that the coolant nozzle of the internal gear grinding machine according to the present disclosure is arranged on a tube which is shiftably guided in a guideway and at the same time serves the supply of coolant to the nozzle.

Particularly, a toothed rack is arranged on the tube, which meshes with a pinion. Beside the guidance of the coolant nozzle and the supply of the coolant, the tube serves as a carriage of a linear drive. In this way, a reliable adjustment of the coolant nozzle can be achieved in the smallest installation space. The pinion is driven via a motor of the drive of the coolant nozzle, for example via an electric motor. The pinion can be a normal gear wheel or a worm pinion, so that a worm drive is achieved.

Alternatively or in addition, it can be provided that the guideway of the tube includes an anti-rotation protection. The guideway of the tube thus prevents that during adjustment of the position of the coolant nozzle for adaptation to the varying radius of the grinding wheel the tube is rotated inadvertently.

Furthermore, it can be provided in accordance with the present disclosure that the tube includes an opening via which it is connected with a space filled with coolant, in order to supply the coolant nozzle with coolant, wherein the tube is shiftable with respect to the space filled with coolant. As a result, no moving parts such as e.g. hoses are required for supplying the coolant to the tube. In particular, it can be provided that the end of the tube opposite the coolant nozzle is open and opens into the space filled with coolant.

In accordance with the present disclosure, a seal furthermore can be provided, which rests against the outer circumference of the tube and seals the space filled with the coolant.

Furthermore, it can be provided that the linear guideway of the tube is arranged inside the space filled with coolant. It can likewise be provided that the anti-rotation protection for the tube is arranged inside the space filled with coolant.

Furthermore, it can be provided according to the present disclosure that the pinion of the drive is arranged in the space filled with coolant. Advantageously, the toothed rack then also is arranged on the tube in the space filled with coolant. The motor can lie outside this space and the shaft for driving the pinion can be guided through the wall of the space. All this allows a particularly simple arrangement with a minimum of sealing effort and a minimum of installation space.

The configuration of the adjustable coolant nozzle as described last can be employed not only in internal gear grinding machines, but generally in gear grinding machines and in particular also in external gear grinding machines.

Therefore, the present disclosure furthermore comprises a gear grinding machine with a grinding spindle and with an adjustable coolant nozzle, wherein the coolant nozzle is arranged in a tube which serves the supply of the coolant to the nozzle, wherein the tube includes an opening via which it is connected with a space filled with coolant, in order to supply the coolant nozzle with coolant. Furthermore, the tube is shiftable with respect to the space filled with coolant, wherein a toothed rack which meshes with the pinion is arranged on the tube. As a result, the drive for adjusting the position of the coolant nozzle can be integrated into the linear guideway provided by the tube in the most confined space.

Advantageously, the pinion of the drive is arranged in the space filled with coolant. Furthermore advantageously, the toothed rack also is arranged in the space filled with coolant.

The arrangement for adjusting the coolant nozzle can be configured as already set forth above. In particular, an anti-rotation protection can be provided for the tube.

The gear grinding machine described last also can include the further features related to the coolant nozzle and its arrangement, as they have been described above. In particular, the linear guideway formed by the tube can be arranged in the grinding plane of the grinding machine.

Furthermore, the adjustment direction of the linear guideway formed by the tube can extend tangentially to the circumference of the grinding wheel. Furthermore, the coolant nozzle can be oriented transversely to the adjustment direction of the linear guideway and hence to the longitudinal axis of the tube.

Furthermore, the adjustment direction of the linear guideway can be inclined with respect to the immersion direction and with respect to a plane vertical to the immersion direction, wherein the angle to the plane vertical to the immersion direction advantageously is between 5° and 45°.

Furthermore, it can be provided that the adjustment direction of the linear guideway is inclined upwards towards the nozzle.

Alternatively or in addition, it can be provided in the present disclosure that the spraying direction of the coolant nozzle is arranged with an inclination to the direction of immersion of the grinding head into the workpiece, advantageously in an angular range between 5° and 40°, wherein the spraying direction advantageously extends forwards and downwards towards the workpiece.

Furthermore, the tube with the coolant nozzle can be arranged above the grinding wheel on the grinding arm.

Furthermore advantageously, the gear grinding machine described last includes a controller which actuates the drive for adjusting the coolant nozzle and readjusts the coolant nozzle. In particular, this controller is configured such as has been set forth above in accordance with the first aspect of the present disclosure.

The gear grinding machine described last can of course be an internal gear grinding machine as it has been described above in detail. It can, however, also be an external gear grinding machine.

Beside the gear grinding machines as they have been described above, the present disclosure furthermore comprises a coolant nozzle with a drive, as it has been described above. In particular, the drive comprises a pinion which meshes with a toothed rack arranged on a tube, wherein the coolant nozzle is arranged on the tube and via the same is supplied with coolant. Advantageously, coolant nozzle and drive are configured such as has already been set forth above. In particular, the tube can have an opening via which it is connected with a space filled with coolant, in order to supply the coolant nozzle with coolant. Furthermore, the tube can be shiftable with respect to the space filled with coolant.

The present disclosure particularly is employed in internal gear grinding machines, in which the grinding spindle is arranged on the grinding arm without interposition of an axis of rotation and/or in which the grinding spindle is arranged on the grinding arm without interposition of a shift axis and/or wherein the grinding spindle is arranged on the grinding arm without interposition of an axis extending in immersion direction.

In particular, the present disclosure particularly is employed in such internal gear grinding machines in which the grinding spindle is rigidly arranged on the grinding arm and the movements necessary for grinding except for the rotary movement of the grinding wheel are effected via a movement of the entire grinding arm.

The present disclosure can, however, also be employed in such internal gear grinding machines in which the grinding spindle is arranged on a movable part of the grinding arm forming a grinding head, which is movable with respect to the rest of the grinding arm via one or more axes of movement. In this case, the adjustable coolant nozzle according to the present disclosure advantageously is arranged on the movable part of the grinding arm and hence is moved along with the grinding wheel.

Particularly, however, the coolant nozzle according to the present disclosure is employed in internal gear grinding machines, in which the grinding arm is movable via axes which are arranged outside a radius of a workpiece to be machined. Furthermore, it can be provided that the grinding arm is rotatable via an axis of rotation and/or movable in immersion direction via a first linear axis and/or is shiftable in direction of the axis of rotation of the grinding spindle via a shift axis and/or is shiftable in engagement direction via a linear axis.

The present disclosure will now be explained in detail with reference to exemplary embodiments and drawings.

### BRIEF DESCRIPTION OF THE FIGURES

FIG. 1 shows a first exemplary embodiment of a grinding arm of an internal gear grinding machine with adjustable coolant nozzle according to the present disclosure, wherein the coolant nozzle is in a first position.

FIG. 2 shows the exemplary embodiment shown in FIG. 1, wherein the coolant nozzle is in a second position.

FIG. 3 shows an exemplary embodiment of a gear grinding machine according to the present disclosure with the grinding arm according to the present disclosure.

### DETAILED DESCRIPTION

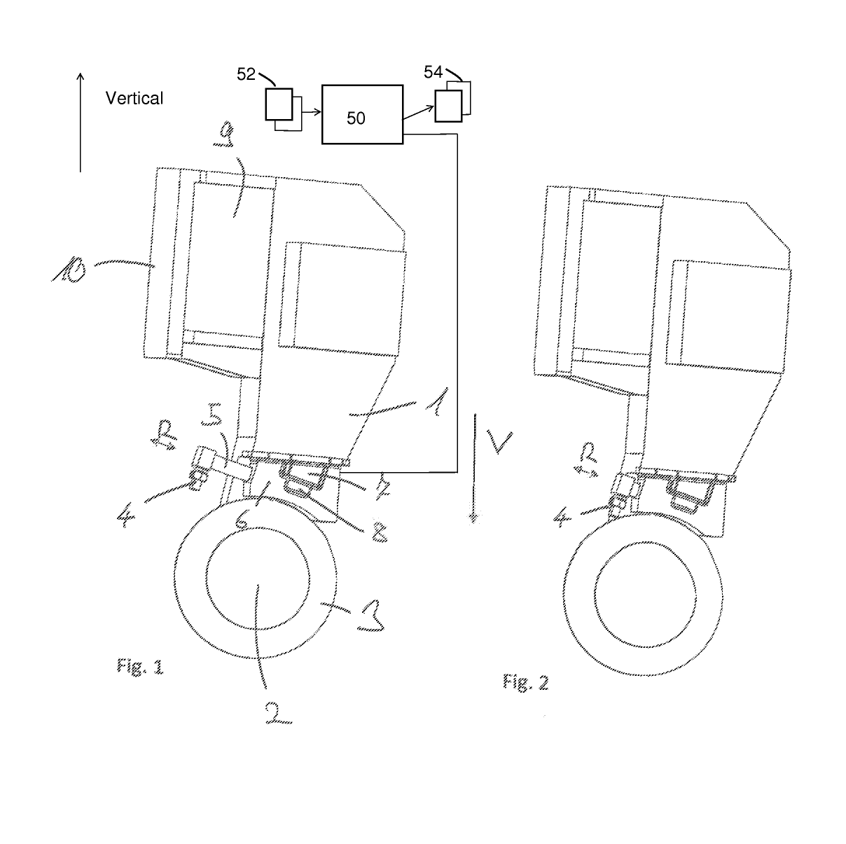

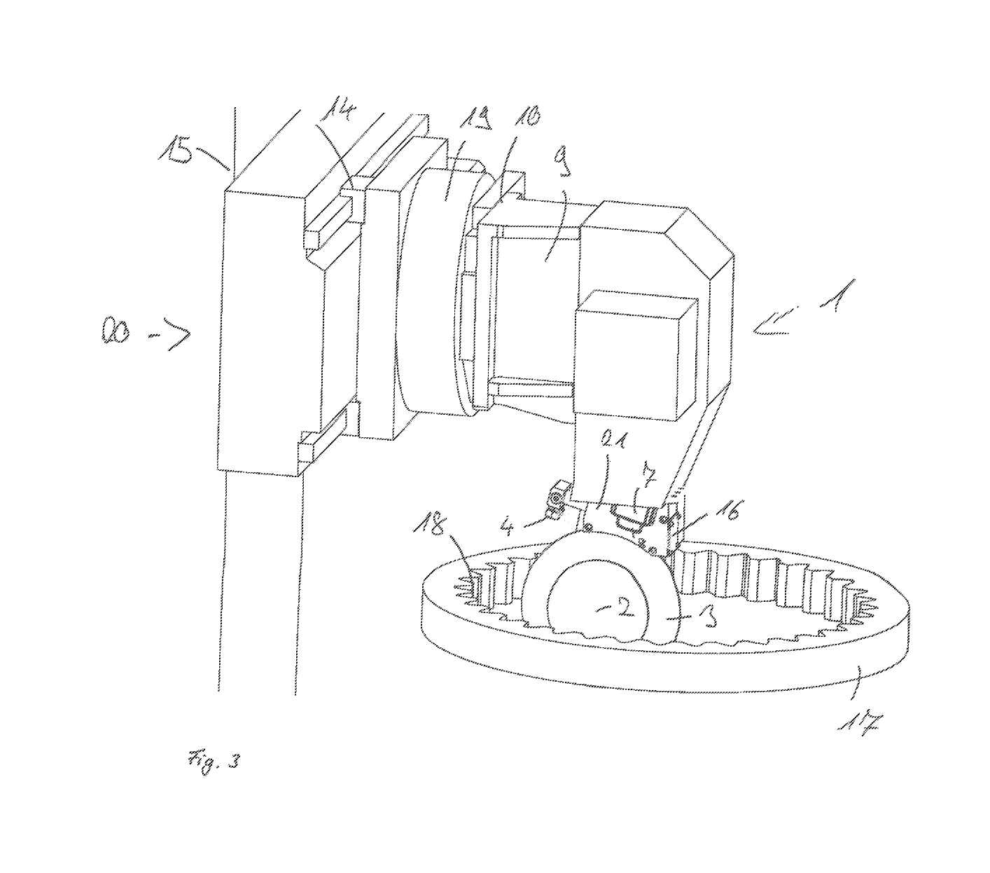

FIGS. 1 and 2 show a first exemplary embodiment of an internal gear grinding machine according to the present disclosure. There is provided a grinding arm 1, at whose lower end a grinding spindle 2 with a grinding wheel 3 clamped thereto is arranged. Via the grinding arm 1, the grinding wheel 3 can be introduced in immersion direction V into the inner region of a workpiece which is to be provided with an internal toothing. In FIGS. 1 and 2, the workpiece would be arranged on the left beside the grinding wheel below the housing portion 9 of the grinding arm 1 extending to the outside in horizontal direction.

In the exemplary embodiment, the grinding spindle 2 is rigidly arranged on the grinding arm 1, so that all movements for grinding except the rotary movement of the grinding wheel 3 are performed by the movement of the entire grinding arm. Via the connection surface 10, the grinding arm therefore is connected with a machine column 20 shown in FIG. 3, which includes the necessary axes of movement.

In the exemplary embodiment, the axes of movement hence lie outside the workpiece 17 to be machined and for example might also be used for producing external toothings with another grinding head. The present disclosure can, however, also be used in internal gear grinding machines with a special internal grinding head which has its own axes of movement.

In accordance with the present disclosure, the internal gear grinding machine includes a coolant nozzle 4 via which the cooling lubricant can be sprayed into the machining zone. To adapt the position of the nozzle to the grinding wheel diameter of the grinding wheel 3, which is reduced during grinding, the position of the coolant nozzle 4 is adjustable via a linear guideway.

The coolant nozzle 4 therefore is arranged on a carriage which is formed by a tube 5 which at the same time serves the supply of coolant. The tube 5 is linearly shiftable in a housing 6. Furthermore, an anti-rotation protection is provided for the tube 5. The anti-rotation protection may include an anti-rotation element, such as a locking mechanism including a locking pin. However, other anti-rotation elements may be used.

Within the housing 6, a toothed rack is arranged on the tube 5, which meshes with a pinion 8 which is only shown here schematically. The pinion 8 is driven via a motor 7 which likewise is shown here only schematically. In particular, the pinion is connected with the motor via a transmission. By rotating the pinion, the carriage formed by the tube 5 can be shifted linearly. As pinion, a normal gear wheel or a worm pinion can be used.

The drive motor 7 for adjusting the position of the coolant nozzle 4 is actuated via the NC controller, such as controller 50, of the grinding machine, which thus automatically can perform the readjustment of the coolant nozzle. Controller 50 receives information from various sensors 52 coupled to the gear cutting machine, and thus may determine the various parameters noted herein. Controller 50 is not only coupled to the drive motor 7, but also various other actuators 54, such as the actuators for controlling operation of the gear grinding machine as described herein.

Furthermore, the coolant nozzle is shiftable orthogonal to the grinding spindle axis. The linear guideway formed by the housing 6 and the tube 5 is arranged vertically above the grinding wheel, namely in the plane formed by the grinding wheel 3. The adjustment direction R of the linear guideway is inclined with respect to a plane vertical to the immersion direction V and arranged substantially tangentially to the circumference of the grinding wheel 3.

The coolant nozzle 4 is arranged at an angle of 90° to the adjustment direction R of the linear guideway formed by the tube 5. In the present disclosure it furthermore is provided that the spraying direction of the coolant nozzle 4 is arranged with an inclination to the immersion direction V of the grinding head into the workpiece, namely advantageously in an angular range between 5° and 40°.

The construction of the linear guideway not shown in the Figures will now be described in detail:

In the housing 21 a linear guideway is provided for the tube 5, which also includes an anti-rotation protection. Furthermore, the tube 5 ends on the back in a space which is filled with coolant via a supply conduit. Despite the adjustability of the tube, an easy supply of the coolant to the tube and from the tube to the coolant nozzle 4 thereby is ensured. The linear guideway for the tube is arranged in the region of the space filled with coolant, so that merely a single seal is required for sealing the tube 5 with respect to the space filled with coolant.

The drive unit for driving the tube is combined with the linear guideway as follows:

The toothed rack for moving the tube is arranged on the tube 5 likewise in the region of the space filled with coolant, so that there are no sealing problems caused by the drive. The pinion 8 of the drive likewise is arranged in this space. Advantageously, a rotary union is provided for the shaft of the pinion, so that the motor 7 can be arranged outside the space filled with coolant. The space filled with coolant rearwardly is closed to the outside by a cover 16.

As shown in FIG. 3, the drive according to the present disclosure for adjusting the coolant nozzle is arranged directly above the grinding wheel on the grinding arm of the internal grinding head. Such adjusting unit for the coolant nozzle might, however, also be employed for external gear grinding machines, when there is likewise desired a particularly space-saving arrangement.

FIG. 3 also reveals the further construction of the internal gear grinding machine according to the present disclosure. The grinding arm 1 extending in immersion direction is connected with a machine column via the housing portion 9 extending in engagement direction, on which axes of movement are provided, which perform the movements necessary for generating the desired grinding profile.

Thus, a linear axis of movement 15 is provided, by which the grinding arm can be moved in immersion direction. Furthermore, a linear axis of movement 14 is provided, by which the grinding arm can be shifted orthogonal to the immersion direction. Furthermore, an axis of rotation 19 is provided, in order to rotate the grinding arm and thus provide for helical toothings.

There is also provided a further linear axis of movement, by which the grinding arm can be moved in engagement direction, in order to bring the grinding wheel in engagement with the workpiece 17. Furthermore, an axis of rotation is provided for rotating the workpiece.

1. An internal gear grinding machine comprising a grinding arm, on which a grinding spindle is arranged, and with an adjustable coolant nozzle, wherein the coolant nozzle is adjustable via a drive.

2. The internal gear grinding machine according to claim 1, further comprising a controller which actuates the drive for adjusting the coolant nozzle and readjusts the coolant nozzle.

3. The internal gear grinding machine according to claim 1, wherein the coolant nozzle is arranged vertically above a grinding wheel on the grinding arm.

4. The internal gear grinding machine according to claim 3, wherein the coolant nozzle is shiftably guided via a linear guideway, wherein the linear guideway is arranged in a grinding plane of the grinding wheel and wherein the linear guideway includes an anti-rotation protection.

5. The internal gear grinding machine according to claim 3, wherein the coolant nozzle is shiftably guided via a linear guideway, and wherein the linear guideway includes an anti-rotation element.

6. The internal gear grinding machine according to claim 4, with a grinding arm on which a grinding spindle is arranged and with a coolant nozzle adjustable via a linear guideway, wherein an adjustment direction of the linear guideway is inclined with respect to an immersion direction and/or with respect to a plane vertical to the immersion direction, wherein an angle to the plane vertical to the immersion direction is between 5° and 40° and/or the adjustment direction of the linear guideway extends tangentially to a circumference of the grinding wheel, wherein the adjustment direction of the linear guideway extends upwards towards the nozzle and/or the coolant nozzle is oriented transversely to the adjustment direction of the linear guideway.

7. The internal gear grinding machine according to claim 6, wherein the coolant nozzle is arranged on a tube which is shiftably guided in a guideway and at the same time serves the supply of coolant to the nozzle.

8. The internal gear grinding machine according to claim 7, wherein a toothed rack is arranged on the tube, which meshes with a pinion of the drive and/or wherein the guideway of the tube includes an anti-rotation protection.

9. The internal gear grinding machine according to claim 8, wherein the tube has an opening via which it is connected with a space filled with coolant, in order to supply the coolant nozzle with coolant, wherein the tube is shiftable with respect to the space filled with coolant, wherein an end of the tube opposite the coolant nozzle is open and opens into the space filled with coolant.

10. The internal gear grinding machine according to claim 9, wherein the pinion of the drive is arranged in the space filled with coolant.

11. A gear grinding machine with a grinding spindle and with an adjustable coolant nozzle, wherein the coolant nozzle is arranged on a tube which serves the supply of coolant to the nozzle, wherein the tube has an opening via which it is connected with a space filled with coolant, in order to supply the coolant nozzle with coolant, wherein the tube is shiftable with respect to the space filled with coolant and wherein a toothed rack is arranged on the tube, which meshes with a pinion of a drive, wherein the pinion of the drive is arranged in the space filled with coolant.

12. The gear grinding machine according to claim 10, further comprising a controller which actuates the drive for adjusting the coolant nozzle and readjusts the coolant nozzle.

13. The gear grinding machine according to claim 10, wherein the coolant nozzle is arranged vertically above a grinding wheel on a grinding arm.

14. The gear grinding machine according to claim 13, wherein the coolant nozzle is shiftably guided via a linear guideway, wherein the linear guideway is arranged in a grinding plane of the grinding wheel and wherein the linear guideway includes an anti-rotation protection.
